(19) United States
(12) Patent Application Publication
(10) Pub. No.: US 2003/0173189 A1
(43) Pub. Date: Sep. 18, 2003

(54) Stocker conveyor particle removing system

(75) Inventors: Wen-Ming Chen, Mia-Lin Hsien (TW); Wen-Chi Wang, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/100,366

(22) Filed: Mar. 18, 2002

(51) Int. Cl. B65G 49/07

(52) U.S. Cl. 198/493; 414/935

(57) ABSTRACT

A cover or housing which spans an output port of a first station and an input port of a second station in a manufacturing facility, for example, and covers or houses a conveyor extending between the stations for conveying articles from the first station to the second station. A source of nitrogen gas or clean dry air is provided in communication with the housing interior, and at least one exhaust fan is provided on the housing. As articles are conveyed from the first station to the second station, nitrogen gas or clean dry air is blown into the housing and drawn therefrom through the exhaust fan or fans, such that the flowing gas or air removes particles from the articles as they are carried to the second station.

### FIELD OF THE INVENTION

The present invention generally relates to a stocker conveyor in an automatic material handling system and more particularly, relates to a conveyor which is equipped with a nitrogen or air purge for blowing potential contaminating particles from pods, containers or articles transported using the conveyor.

### BACKGROUND OF THE INVENTION

In the manufacturing of a product, the product is usually processed at many work stations or processing machines. The transporting or conveying of partially-finished products, or work-in-process (WIP) parts, is an important aspect in the total manufacturing process. The careful conveying of semiconductor wafers is especially important in the manufacturing of integrated circuit chips due to the delicate nature of the chips. Furthermore, in fabricating an IC product, a multiplicity of fabrication steps, i.e., as many as several hundred, is usually required to complete the fabrication process. A semiconductor wafer or IC chip must be transported between various process stations in order to facilitate various fabrication processes.

For instance, to complete the fabrication of an IC chip, various steps of deposition, cleaning, ion implantation, etching, and passivation must be carried out before an IC chip is packaged for shipment. Each of these fabrication steps must be performed in a different process machine, i.e., a chemical vapor deposition chamber, an ion implantation chamber, an etcher, etc. A partially processed semiconductor wafer must be conveyed between various work stations many times before the fabrication process is completed. The safe conveying and accurate tracking of such semiconductor wafers or work-in-process parts in a semiconductor fabrication facility is therefore an important aspect of the total fabrication process.

Conventionally, partially finished semiconductor wafers or WIP parts are conveyed in a fabrication plant by automatically-guided vehicles (AGVs) or overhead transport vehicles (OHTs) that travel on predetermined routes or tracks. For the conveying of semiconductor wafers, the wafers are normally loaded into cassettes or SMIF (standardized mechanical interface) pods and then picked up and placed in the automatic conveying vehicles. For identifying and locating the various semiconductor wafers or WIP parts being transported, the cassettes or pods are normally labeled with a tag positioned on the side of the cassette or pod. The tags can be read automatically by a tag reader that is mounted on the guard rails of the conveying vehicle. The AGVs and OHTs normally transport the pods from bay to bay along an interbay loop, and eventually deliver the pods to a robotic storage house, or “stocker”, which automatically delivers the pods to an intrabay loop.

In an automatic material handling system (AMHS), stockers are widely used in conjunction with automatically guided or overhead transport vehicles, either on the ground or suspended on tracks, for the storing and transporting of semiconductor wafers in SMIF pods or in wafer cassettes. For instance, as shown in FIG. 1 of the drawings, three possible configurations for utilizing a stocker are illustrated. In case A, a stocker 10 is utilized for storing WIP wafers in SMIF pods and transporting them first to tool A, then to tool B, and finally to tool C for three separate processing steps to be conducted on the wafers. After the processing in tool C is completed, the SMIF pod is returned to a stocker 10 for possible conveying to another stocker. The configuration shown in case A is theoretically workable but hardly ever possible in a fabrication environment, since the tools or processing equipment cannot always be arranged nearby to accommodate the processing of wafers in the stocker 10.

In the second configuration, case B shown in FIG. 1, a stocker 12 and a plurality of buffer stations A, B and C are used to accommodate three different processes to be conducted in tool A, tool B and tool C, respectively. As shown in FIG. 1, a SMIF pod may be first delivered to buffer station A from the stocker 12 and waits there for processing in tool A. Buffer stations B and C are similarly utilized in connection with tools B and C. The buffer stations A, B and C therefore become holding stations for conducting processes on the wafers. This configuration provides a workable solution to the fabrication process, but requires excessive floor space because of the additional buffer stations required. The configuration is therefore not feasible for use in a semiconductor fabrication facility.

In the third configuration, shown as case C in FIG. 1, a stocker 14 is provided for controlling the storage and conveying of WIP wafers to tools A, B and C. It is seen that after a SMIF pod is delivered to one of the three tools, the SMIF pod is always returned to to the stocker 14 before it is sent to the next processing tool. This is a viable process since only one stocker is required for handling three different processing tools and no buffer station is needed. The configuration shown in case C illustrates that the frequency of use of the stocker is extremely high since the stocker itself is used as a buffer station for all three tools. The accessing of the stocker 14 is therefore much more frequent than that required in the previous two configurations.

FIG. 2 illustrates a schematic of a typical automatic material handling system 20 that utilizes a central corridor 22, a plurality of bays 24 and a multiplicity of process machines 26. A multiplicity of stockers 30 are utilized for providing input/output to the bay 24, or to processing machines 26 located on the bay 24. The central corridor 22 designed for bay layout is frequently used in an efficient automatic material handling system to perform lot transportation between bays. In this configuration, the stockers 30 of the automatic material handling system become the pathway for both input and output of the bay. Unfortunately, the stocker 30 frequently becomes a bottleneck for internal transportation. It has been observed that a major cause for the bottlenecking at the stockers 30 is the input/output ports of the stockers.

In modern semiconductor fabrication facilities, especially for the 200 mm or 300 mm FAB plants, automatic guided vehicles (AGV) and overhead transport vehicles (OHT) are extensively used to automate the wafer transport process as much as possible. The AGV and OHT utilize the input/output ports of a stocker to load or unload wafer lots, i.e., normally stored in SMIF pods. However, in the current configuration and design of stockers, an AGV or OHT when approaching a stocker blocks both the input and the output ports even though it only performs a single operation of either loading or unloading. This is shown in FIGS. 3 and 4.

FIG. 3 is a perspective view of an overhead transport vehicle system 32 consisting of two vehicles 34, 36 that travel on a track 38. While both an input port 40 and an output port 42 are provided on the stocker 30, the overhead transport vehicle 36 stopped at the position for unloading a lot 44 into the input port 40, effectively blocks the access to the output port 42. As a result, the other overhead transport vehicle 34 waits on the track 38 for input from stocker 30 and cannot access the stocker until the overhead transport vehicle 36 has moved out of the way. The arrangment shown in FIG. 3 results in considerable time loss since the stocker 30 can only be accessed for either input or output, but not both simultaneously. This significantly affects the efficiency of the input and output operations of the stocker 30.

A conventional automatic guided vehicle (AGV) system used in a conventional stocker configuration is shown in FIG. 4. The AGV system 48 consists of two automatic guided vehicles 50 and 52 with vehicle 52 stopped in front of the stocker 30. The stocker 30 is equipped with an input port 54 and an output port 56. As shown in FIG. 4, the automatic guided vehicle 52 approaches the output port 56 for accepting an output from stocker 30, but at the same time, the input port 54 is also blocked by the vehicle 52 such that the second vehicle 50 must wait for input until the vehicle 52 has moved out of the way. The conventional stocker 30 therefore cannot be efficiently operated since the input port 54 and the output port 56 cannot be accessed by automatic guided vehicles simultaneously to perform loading and unloading at the same time.

Another conveyor system frequently used in manufacturing facilities includes a conveyor belt system in which an endless belt traverses multiple rollers to carry articles from one location to another. These conveyor belt systems include stocker conveyors which provide a useful mechanism for transport of semiconductor wafer pods into stockers in semiconductor production facilities. However, the pods often accumulate potential wafer-contaminating particles during such transport. Accordingly, the pods carry the particles to the stockers and eventually, to the processing stations, where the particles increase the likelihood of wafer contamination upon subsequent internalization of the pods into the load ports of the processing stations.

### SUMMARY OF THE INVENTION

Accordingly, an object of the present invention is to provide a system for removing particles from articles carried on a conveyor.

Another object of the present invention is to provide a system for removing particles from semiconductor wafer pods carried on a conveyor in a semiconductor production facility.

Still another object of the present invention is to provide a stocker conveyor particle removing system which utilizes a continuous flow of nitrogen gas or clean, dry air (CDA) flow to remove particles from the surfaces of a semiconductor wafer pod as the pod is transported into a wafer stocker in a semiconductor production facility.

Yet another object of the present invention is to provide a stocker conveyor particle removing system which includes an ionizer or static electricity remover for removing particles from a wafer pod before nitrogen- or air-induced removal of the remaining particles from the wafer pod.

A still further object of the present invention is to provide a stocker conveyor particle removing system provided with a stopping and starting mechanism for automatically initiating and terminating, respectively, operation of the system as needed.

In accordance with these and other objects and advantages, the present invention comprises a cover or housing which spans the output port of a first station and an input port of a second station in a manufacturing facility, for example, and covers or houses a conveyor extending between the stations for conveying articles from the first station to the second station. A source of nitrogen gas or clean dry air is provided in communication with the housing interior, and at least one exhaust fan is provided on the housing. As articles are conveyed from the first station to the second station, nitrogen gas or clean dry air is blown into the hosuing and drawn therefrom through the exhaust fan or fans, such that the flowing gas or air removes particles from the articles as they are carried to the second station.

### BRIEF DESCRIPTION OF THE DRAWINGS

The present invention will now be described, by way of example, with reference to the accompanying drawings, in which:

FIG. 1 is a schematic view illustrating three possible configurations for utilizing a stocker in a manufacturing facility;

FIG. 2 is a schematic view of a typical automatic material handling system which utilizes a central corridor, a plurality of bays and a multiplicity of process machines;

FIG. 3 is a perspective view of a conventional overhead transport vehicle (OHT) system;

FIG. 4 is a perspective view of a conventional automatic guided vehicle (AGV) system;

FIG. 5 is a side view of a conventional stocker conveyor in a semiconductor production facility;

FIG. 6 is a side view of an illustrative embodiment of the stocker conveyor particle removing system of the present invention;

FIG. 7 is a sectional view, taken along section lines 7-7 in FIG. 6, of the housing component of the stocker conveyor particle removing system of the present invention;

FIG. 8 is a top view, partially in section, of the stocker conveyor particle removing system of the present invention;

FIG. 9 is a side view of another illustrative embodiment of the stocker conveyor particle removing system of the present invention; and

FIG. 10 is an enlarged sectional view of the housing component of still another illustrative embodiment of the stocker conveyor particle removing system of the present invention.

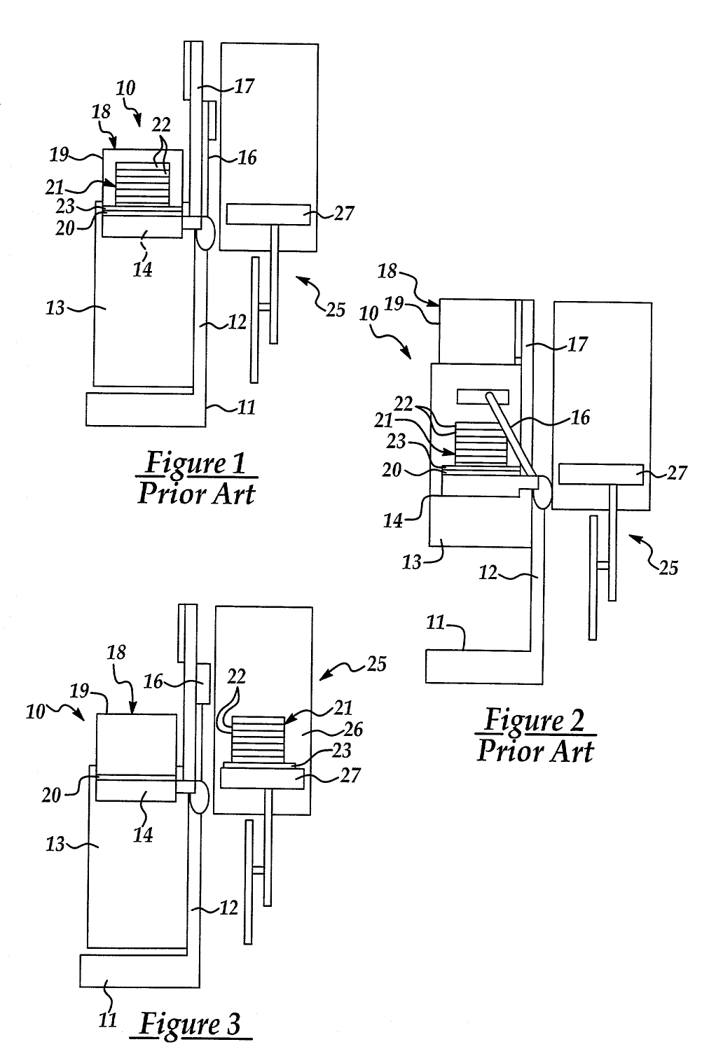

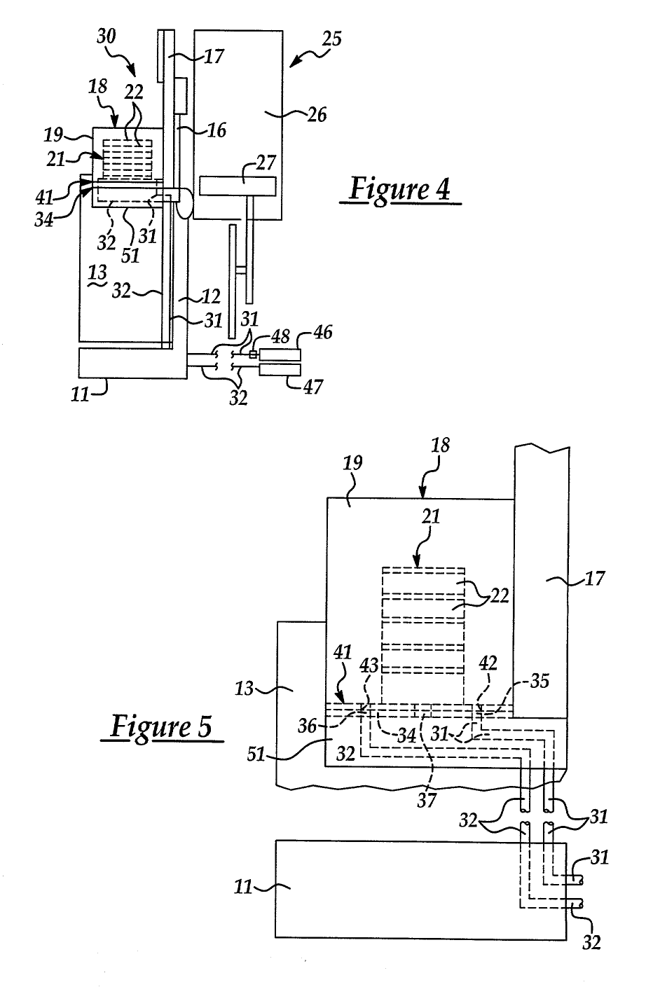

### DESCRIPTION OF THE PREFERRED EMBODIMENTS

When used herein, the term, “gas” shall mean nitrogen gas, clean dry air or other inert gas. When used herein, the term, “article conveyor” shall mean any conveyor belt, automatically it guided vehicles (AGVs) or overhead transport vehicles (OHTs) used to transport articles in a manufacturing or other facility. Therefore, while references may be made to stocker conveyors which utilize a conveyor belt to transport articles from one location to another, the present invention contemplates other types of transport apparatus as suitable for implemetation of the present invention.

The present invention has particularly beneficial utility in application to removing potential wafer-contaminating particles from wafer pods in semiconductor production facilities. However, the invention is not so limited in application and while references may be made to such semiconductor production facilities, the invention may be more generally applicable to removing particles from articles in a variety of industrial and product applications.

Referring initially to FIG. 5 of the drawings, a typical conventional stocker conveyor used in semiconductor production facilities is generally indicated by reference numeral 1. The stocker conveyor 1 operates in a clean room environment and includes an endless conveyor belt 2 that is used to continually transport wafer pods 8 from the output port of a station 4, which may be a wafer processing station, a wafer pod storage station or other station, and into the input port of a stocker 6. From the stocker 6, the pods 8 are transported by means of automatic guided vehicles (AGVs), overhead transport vehicles (OHTs) or additional conveyor belts 2 to processing stations or other destinations in the semiconductor production facility.

Although the stocker conveyor 1 operates in a clean room environment, such an environment is not completely free of dirt, dust and other particles which have the potential to contaminate integrated circuits on the wafers contained in the pods 8 during the subsequent wafer processing steps. Accordingly, the transport interval between the station 4 and the stocker 6 provides additional occasion for dirt, dust and other potentially contaminating particles to collect on the surfaces of the pod 8, particularly the bottom surface thereof.

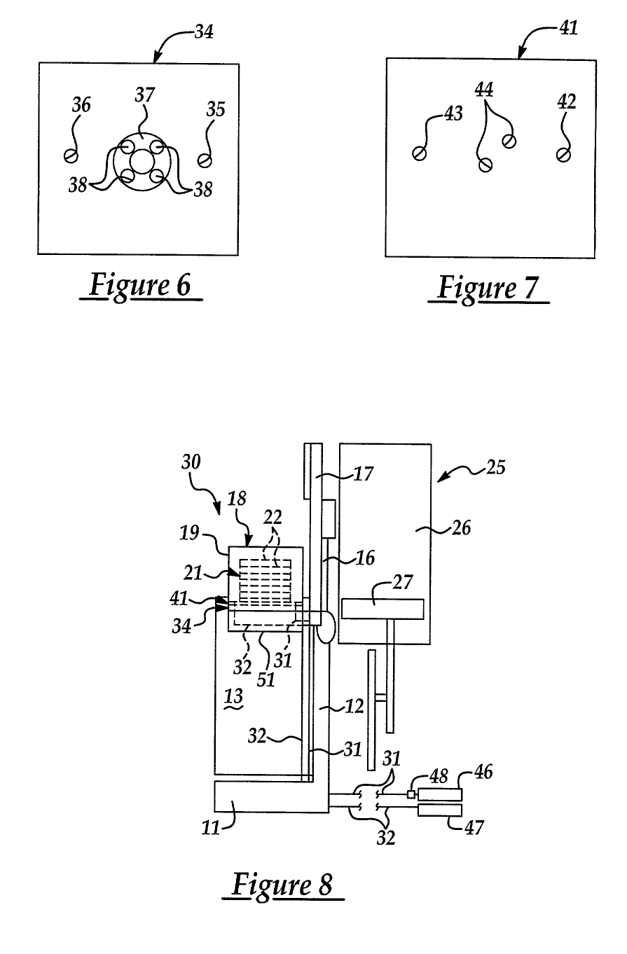

An illustrative embodiment of the stocker conveyor particle removing system of the present invention is generally indicated by reference numeral 60 in FIGS. 6-8 of the drawings. The stocker conveyor particle removing system 60 includes an elongated cover or housing 61 which is connected to the output port of the station 4 at an entry end 65 and to the input port of the stocker 6 at an exit end 66 and defines a housing interior 62 (FIG. 7) that spans the station 4 and stocker 6. The housing 61 is typically constructed of plexiglass® or any other anti-ESD material. The conveyor belt 2 of the conventional stocker conveyor 1 extends through the housing interior 62, as illustrated in cross-section in FIG. 7. Multiple conduit openings 78 extend through the vertical side walls 67 of the conveyor housing 61, adjacent to the bottom edge of the side wall 67. Although seven conduit openings 78 are shown in each side wall 67, it is understood that any desired number of the conduit openings 61 may be provided in each side wall 67. An exhaust port 63, provided with at least one exhaust fan 64, is provided in the top 68 of the housing 61 for evacuating gas or air from the housing interior 62, for purposes hereinafter described. An exhaust duct (not illustrated) typically conducts the gas or air from the exhaust port 63 to a suitable outlet.

As illustrated in FIG. 8, the particle removing system 60 further includes a pair of purge gas delivery systems 70, each of which is designed to distribute pressurized nitrogen gas or clean, dry air through the multiple conduit openings 78 in the corresponding side wall 67 of the conveyor housing 61, and into the housing interior 67 thereof. Each purge gas delivery system 70 includes a conventional gas source 71 containing a supply of compressed nitrogen gas or clean, dry air. A central conduit 72 extends from fluid communication with the outlet of the gas source 71, through one of the conduit openings 78 and terminates in the housing interior 62. Multiple branch conduits 73 may extend from the central conduit 72 and through the remaining respective conduit openings 78, where the branch conduits 73 likewise terminate in the housing interior 62. Each of the conduits 72, 73 is hermetically sealed with respect to the edges of the respective conduit openings

In an alternative embodiment (not shown), each of the conduits 72, 73 may have its own gas source 71, or two, three or more of the conduits 72, 73 may extend from a common gas source 71. Still further in the alternative, the conduits 72, 73 of both purge gas delivery systems 70 may be served by a common gas source 71. It will be recognized by those skilled in the art that numerous variations in number and configuration for the gas source or sources 71 and the conduits 72, 73 may be made without departing from the spirit and scope of the invention.

As further illustrated in FIGS. 7 and 8, a light emitter 83 and a light sensor 85 are provided on the side walls 67, inside the housing interior 62 in aligned relationship to each other and just above the level of the conveyor belt 2, adjacent to the entry end 65 of the housing 61. An additional light emitter 86 and light sensor 87 pair are in like manner provided at the exit end 66 of the housing 61. As illustrated in FIG. 8, each light sensor 85, 87 may be connected to a process controller 77 by means of sensor wiring 81, which process controller 77 is connected to the operational components of each gas source 71 typically by means of additional wiring 79, as illustrated schematically in FIG. 8. The process controller 77 may further be connected to the exhaust fans 64 of the exhaust port 63, or alternatively, the exhaust port 63 may have its own separate control system. Accordingly, each light emitter 83, 86 continually emits a light beam 84 (FIG. 7) which is received by the corresponding aligned light sensor 85, 87. As the conveyor belt 2 carries a pod 8 through the housing interior 62, the pod 8 first interrups the light beam 84 of the emitter 83/sensor 85 pair at the entry end 65 of the housing 61, and this interruption is sensed by the light sensor 85, which sends a signal to the process controller 77 to begin operation of the gas source or sources 71. As it reaches the exit end 66 of the housing 61, the pod 8 interrupts the light beam 84 of the emitter 86/sensor 87 pair at the exit end 66 of the housing 61, and the light sensor 87 sends a signal to the process controller 77 to terminate operation of the gas source or gas sources 71. It will be understood that the present invention contemplates the use of any alternative type of sensor system known by those skilled in the art to detect the presence of the wafer pod 8 at the entry end 65 and the exit end 66 of the housing 61.

Referring again to FIGS. 6 and 7 of the drawings, in typical application of the stocker conveyor particle removing system 60, a pod 8 containing semiconductor wafers (not illustrated) is transported from the output port of the station 4 to the input port of the stocker 6 for ultimate distribution to another location in the semiconductor production plant. After the pod 8 is loaded onto the conveyor belt 2 by means of conventional automated equipment (not illustrated) at the station 4, the conveyor belt 8 carries the pod 8 into the housing interior 62 at the entry end 65 of the housing 61. Accordingly, the pod 8 initially interrupts the light beam 84 emitted by the light emitter 83, and the light sensor 85 senses the light interruption and sends the appropriate message to the process controller 77. The process controller 77, in turn, actuates the operating components of the gas source or sources 71, which deliver nitrogen gas or clean, dry air typically at a pressure of about 80 p.s.i. through the central conduit 72 and branch conduits 73 and into the housing interior 62. The process controller 77 may also actuate the exhaust fans 64 (FIG. 8) of the exhaust port 63. Simultaneously, the exhaust port 63 draws the nitrogen gas or clean, dry air from the housing interior 62 to the exhaust duct (not illustrated). Consequently, a continuous gas or air flow pattern is established inside the housing interior 62, between the high-pressure air or gas discharge ends of the conduits 72, 73 inside the housing interior 62 and the low-pressure exhaust port 63. The flowing gas or air tends to remove dirt, dust and other potential wafer-contaminating particles from the top, front, rear, side and bottom surfaces of the pod 8 during transit of the pod 8 through the housing interior 62, and discharges most or all of the particles with the air or gas through the exhaust port 63. When the pod 8 reaches the light emitter 86/light sensor 87 pair at the exit end 66 of the housing 61, the pod 8 interrupts the light beam 84, and the light sensor 87 sends the appropriate message to the process controller 77, which terminates operation of the air or gas source or sources 71, and the exhaust port 63, if applicable. The pod 8 is finally delivered into the stocker 6 for sorting or temporary storage therein, in conventional fashion.

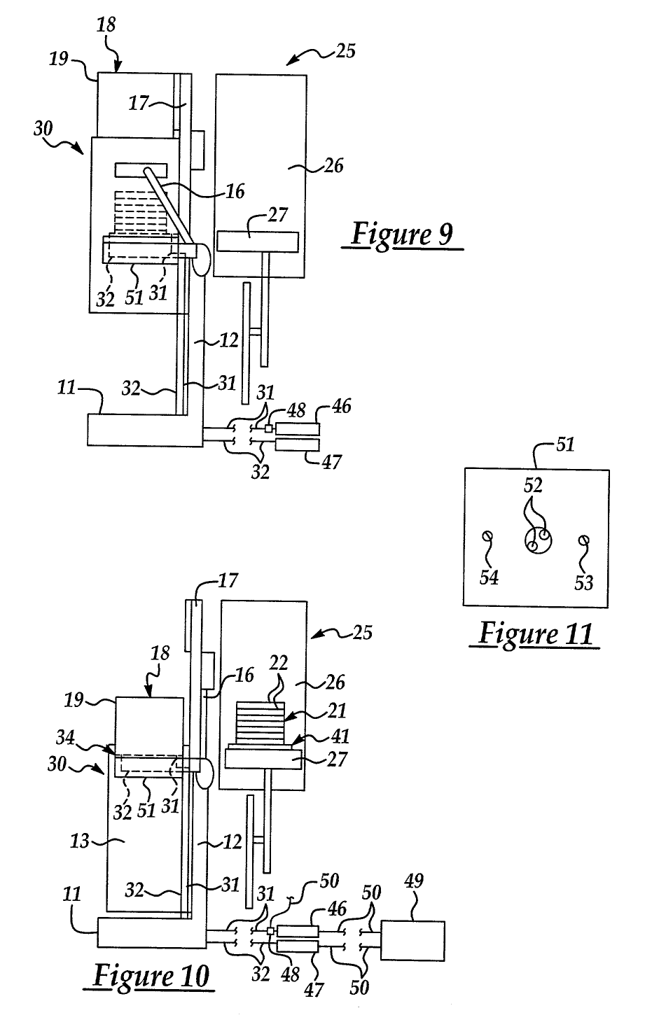

Referring next to FIG. 9 of the drawings, another illustrative embodiment of the particle removing system of the present invention is generally indicated by reference numeral 88 and includes a conventional static electricity remover or ionizer 90, mounted typically on the interior surface of the conveyor housing 61, above or adjacent to the conveyor belt 2. The ionizer 90 may be connected to the process controller 77. Accordingly, upon entry of the wafer pod 8 into the housing interior 62, the ionizer 90 may be operated to remove static electricity from the surfaces of the pod 8 and inhibit static electricity-induced clinging of particles to the pod 8 before the air- or gas-induced removal of the particles from the pod 8 as heretofore described.

An alternative configuration for the conduits 72, 73 of the purge gas delivery system or systems 70 is illustrated in FIG. 10, wherein the discharge end of each conduit 72, 73, instead of extending through the corresponding conduit opening 78 in the housing 61, terminates immediately adjacent to the conduit opening 78, outside the housing 61. Air or gas flowing from the discharge ends of the respective conduits 72, 73 is thus drawn into the corresponding conduit opening 78 due to the air or gas pressure drop induced in the housing interior 62 by the exhaust port 63.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, I claim:

1. A particle removing system for removing particles from articles transported on an article conveyor, said system comprising:
a housing for containing the article conveyor;
a plurality of conduit openings provided in said housing for positioning adjacent to the article conveyor;
at least one gas source provided in fluid communication with said plurality of conduit openings, respectively, for introducing a gas into said housing; and
at least one exhaust fan provided in said housing for drawing said gas from said housing.

2. The system of claim 1 further comprising an ionizer provided in said housing for removing static electricity from the articles.

3. The system of claim 1 wherein said at least one gas source comprises a pair of gas sources.

4. The system of claim 3 further comprising an ionizer provided in said housing for removing static electricity from the articles.

5. The system of claim 1 further comprising a process controller operably connected to said at least one gas source for operating said at least one gas source.

6. The system of claim 5 further comprising an ionizer provided in said housing for removing static electricity from the articles.

7. The system of claim 5 wherein said at least one gas source comprises a pair of gas sources.

8. The system of claim 7 further comprising an ionizer provided in said housing for removing static electricity from the articles.

9. The system of claim 1 further comprising a sensor mechanism provided in said housing at respective ends of said housing for sensing entry of the articles into said housing and exit of the articles from said housing on said article conveyor.

10. The system of claim 9 further comprising an ionizer provided in said housing for removing static electricity from the articles.

11. The system of claim 9 wherein said at least one gas source comprises a pair of gas sources.

12. The system of claim 11 further comprising an ionizer provided in said housing for removing static electricity from the articles.

13. A particle removing system for removing particles from articles transported on an article conveyor, said system comprising:
a housing for containing the article conveyor;
a plurality of conduit openings provided in said housing for positioning adjacent to the article conveyor;
a plurality of conduits extending through said plurality of conduit openings, respectively, and terminating in said housing;
at least one gas source provided in fluid communication with said plurality of conduits, respectively, for introducing a gas into said housing; and
at least one exhaust fan provided in said housing for drawing said gas from said housing.

14. The system of claim 13 further comprising an ionizer provided in said housing for removing static electricity from the articles.

15. The system of claim 13 further comprising a process controller operably connected to said at least one gas source for operating said at least one gas source.

16. The system of claim 15 further comprising an ionizer provided in said housing for removing static electricity from the articles.

17. A method for removing particles from a wafer pod transported on a stocker conveyor, said method comprising the steps of providing a housing over said stocker conveyer, said housing comprising a plurality of conduit openings for positioning adjacent to the article conveyor; at least one gas source provided in fluid communication with said plurality of conduit openings, respectively, for introducing a gas into said housing; and at least one exhaust fan provided in said housing for drawing said gas from said housing;
transporting the wafer pod through said housing on the article conveyor;
introducing a gas into said housing through said plurality of conduit openings by operating said at least one gas source; and
inducing a flow of said gas through said housing by drawing said gas from said housing by operating said at least one exhaust fan, whereby said gas removes the particles from the wafer pod.

18. The method of claim 17 further comprising providing the steps of providing an ionizer in said housing and removing static electricity from the wafer pod by operation of said ionizer.

19. The method of claim 17 further comprising the step of operably connecting a process controller to said at least one gas source for initiating and terminating operation of said at least one gas source.

20. The method of claim 19 further comprising the steps of providing an ionizer in said housing and removing static electricity from the wafer pod by operation of said ionizer.
